(19) United States
(12) Patent Application Publication
(10) Pub. No.: US 2007/0186786 A1
(43) Pub. Date: Aug. 16, 2007

(54) Pan bumper for steam cooker door

(76) Inventors: Richard E. Chitwood, Troy, OH (US); Michael B. Reckner, Dayton, OH (US)

Correspondence Address: THOMPSON HINE LLP;Intellectual Property Group, P.O Box 8801, DAYTON, OH, 45401-8801, US

(21) Appl. No.: 11/354,431

(22) Filed: Feb. 15, 2006

(51) Int. Cl. A47J 37/08

(52) U.S. Cl. 99/401

(57) ABSTRACT

A steam cooker includes at least one pan bumper extending from the interior side of the door for contacting and moving a protruding pan when the door is moved from the open position to the closed position so as to prevent contact between the protruding pan and the sealing member.

### TECHNICAL FIELD

The present application relates generally to steam cookers used to steam food products, and more particularly to a steam cooker including a door and a pan bumper for protecting the door's peripheral sealing member.

### BACKGROUND

Steam cookers have been successfully employed by restaurants, hospitals and other food service operations to prepare quickly and conveniently large quantities of food. Many such cookers are used in high volume situations. Steam cookers of this type include a cooking chamber, which is sized to receive multiple cooking pans containing food products to be cooked; a door; and a gasket placed around the periphery of the door to prevent steam leakage. Under such circumstances, nothing is in place to prevent the cooking pans from colliding with the door gasket and causing damage, such as nicks or cuts. Such repeated collisions can result in a need for gasket replacement. It would be desirable to provide a steam cooker with a feature to avoid such gasket damage.

### SUMMARY

In one aspect, a steam cooker includes a cooking chamber having an access opening with a frame disposed thereabout, a door movable between an open position and a closed position relative to the access opening, a steam generator for providing steam to the cooking chamber, a sealing member positioned at least partly between the frame and an interior side of the door when the door is in the closed position and at least one pan bumper vertically-oriented and positioned toward a hinged side of the door. The at least one pan bumper extends from the interior side of the door and is disposed for contacting and moving a protruding pan when the door is moved from the open position to the closed position so as to prevent contact between the protruding pan and the sealing member.

In another aspect, a steam cooker includes a cooking chamber having an access opening, a door providing access to the cooking chamber, the door movable between an open position and a closed position relative to the access opening, a steam generator for providing steam to the cooking chamber, a sealing member positioned on an interior side of the door to limit egress of steam when the door is in the closed position and at least one pan bumper vertically-oriented and positioned toward a hinged side of the door. The at least one pan bumper extends from the interior side of the door and is located to protrude into the access opening when the door is in the closed position, the pan bumper protruding further away from the interior side of the door than the sealing member.

### BRIEF DESCRIPTION OF THE DRAWINGS

FIG. 1 is perspective view of one embodiment of a steam cooker with a pan bumper;

FIG. 2 is a perspective view of the door of FIG. 1; and

FIG. 3 is a partial top view of the door of FIG. 2 with the pan bumper in accordance with the present invention.

### DETAILED DESCRIPTION

Steam cookers conventionally cook foods by the use of hot steam and may be powered by a steam generator which is either gas fired or electrically powered. In a typical operation of a steam cooker containing a steam generator, the cooker is pre-heated to a predetermined temperature for a period of time to allow the steam generator to reach a peak temperature for vaporizing water into steam. The vegetables or other food items to be steamed are loaded into cooking pans and placed in the cooking chamber and the cooker door is closed. After closing the door, a timer is turned to the desired cook time and steam enters the cooking chamber. When the preset time has elapsed, the steam supply is automatically stopped and the pans of food may be removed. For additional cooking events, the procedure is repeated except that it is generally not necessary to pre-heat the cooker since the previous steaming cycle provides sufficient heat.

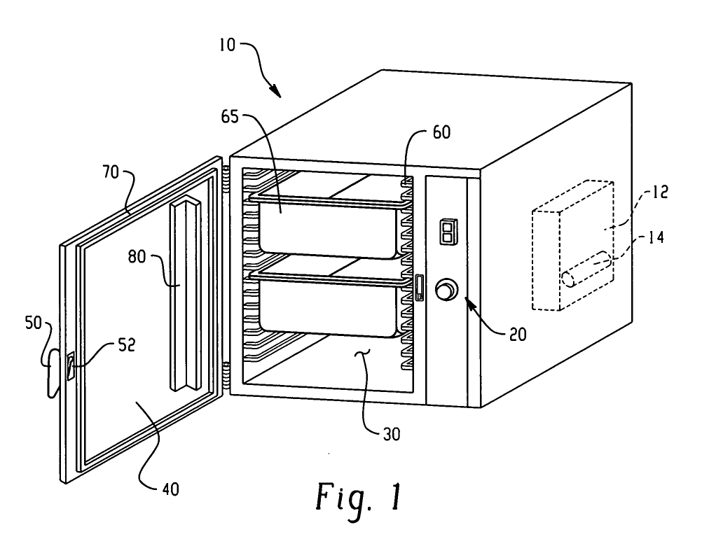

Referring to FIG. 1, a steam cooker 10 includes a steam generator (shown schematically within the cooker at 12) for generating steam, controls 20 to control the operation of the steam cooker 10, and a cooking chamber 30 that is in communication with the steam generator 12. The steam generator 12 could also be situated below the chamber 30 or within the chamber 30 (for example, at the bottom of the chamber 30). A heating element 14 of the generator is also shown schematically. The heating element 14 could be of the electrical type or could be one or more heat exchange tubes through which combustion gases pass. The cooking chamber 30 may be formed by an insulated housing and includes a door 40 movable between an open position and a closed position for providing access to the cooking chamber 30. As shown in FIG. 1, the door 40 includes a handle 50 and associated latch 52. In one embodiment, the cooking chamber 30 takes the form of a substantially rectangular or box-shaped chamber with one or more racks 60 (for example, either a single column of racks or multiple columns of racks) for supporting and receiving cooking pans. The cooking chamber 30 is defined by the door 40, a floor, a ceiling, sidewalls and a rear wall. In one embodiment, the controls 20 are positioned outside the cooking chamber 20 and alongside the door 40. The controls 20 may take any form known in the art, and typically include an on/off switch, indicator lights, a timer, gauges, thermostat, and other suitable electronics.

In one embodiment, the steam generator 12 includes a heating chamber, separate from the cooking chamber 30, where water is heated to generate steam and a steam superheater (not shown) capable of superheating the steam generated in the heating chamber under relatively low pressure conditions. In some embodiments, the cooker 10 operates in a temperature range between about 190 degrees F. and about 250 degrees F. Although the steam cooker 10 shown in FIG. 1 has one cooking chamber 30 and one steam generator, steam cookers having two or more cooking chambers and two or more steam generators are contemplated.

Internal racks 60 to enable a number of cooking pans 65 to be slid in and out of the chamber. Steam cooker 10 is designed to accept a variety of combinations of cooking pans 65. In one example, cooking chamber 30 is capable of accepting four rectangular, flat-bottomed cooking pans having a size of about 12 inches×20 inches and a depth of about 6 inches. In another example, cooking chamber 30 is capable of accepting sixteen rectangular, flat-bottomed cooking pans having a size of about 12 inches×20 inches and a depth of about one inch.

The door 40 is hinged about a vertical axis by hinges 42 arranged alongside a vertical edge of the opening of the cooking chamber 30. The door 40 includes a sealing member 70 that is positioned at least partly between the frame of the cooking chamber 30 and the interior side of the door 40 when the door 40 is in the closed position. In one embodiment, the sealing member 70 is arranged around the interior periphery of the door 40 in order to prevent or limit the escape of steam from the chamber opening. In operation, the sealing member 70 comes into contact against the framing of the cooking chamber 30. In one example, sealing member 70 comprises silicon rubber. However, one skilled in the art would recognize that any suitable material capable of withstanding elevated operating temperatures may be used to provide an appropriate peripheral seal.

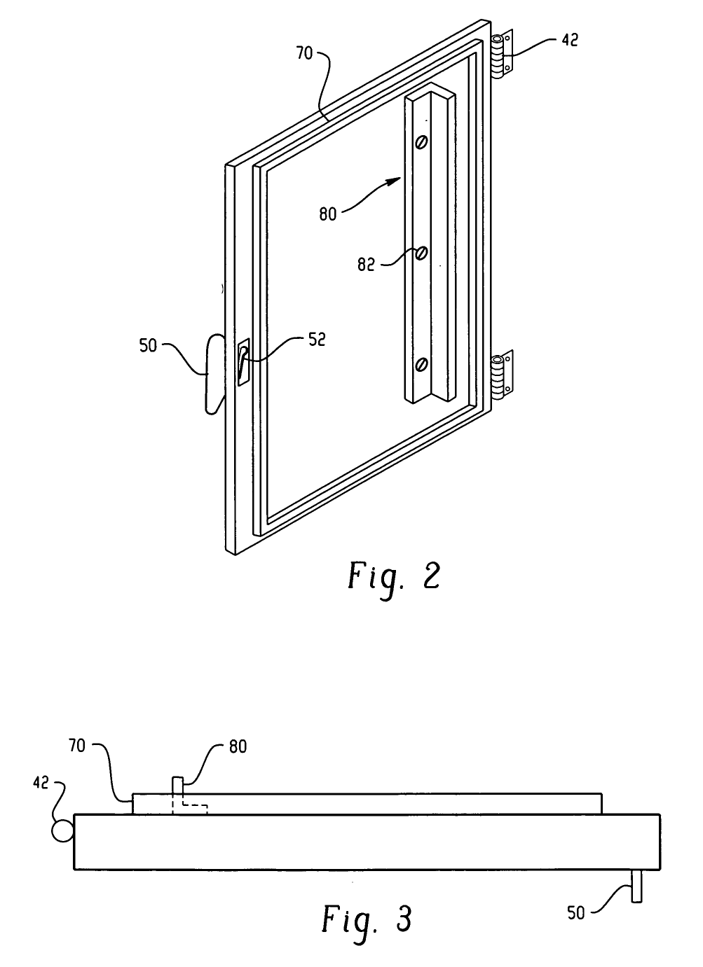

Referring to FIG. 2, the door 40 also includes at least one pan bumper 80. Pan bumper 80 projects from the interior side of the door 40 and is positioned toward the hinged side of the door 40 in order to contact and move the pans 65 that are protruding from the cooking chamber 30. By preventing contact between the pans 65 and the sealing member 70, the pan bumper 80 avoids damage to the sealing member 70, such as nicks and cuts. The illustrated pan bumper 80 takes the form of an L-shaped piece of aluminum having one leg attached to the interior side of the door 40 by fasteners 82. However, welding or other attachment means could be used.

In one embodiment, the pan bumper 80 protrudes further away from the interior side of the door 40 than the sealing member 70 as shown in FIG. 3. This ensures that the pans 65 will not come into contact with the sealing member 70 when the door 40 is in the closed position. The resulting spacing between the pans 65 and door 40 produces a more desirable steam circulation within the cooking chamber 30 for cooking of food items. In another embodiment, a second bumper may be positioned on the back wall of the cooking chamber 30 in order to ensure that the pans 65 will not come into contact with the back wall. By creating a space between the back wall and the pans 65, steam circulation would further be increased.

The illustrated pan bumper 80 is parallel and proximate to the vertically extending portion of the sealing member 70 located on the hinged side of the door 40. In this embodiment, the extent of the pan bumper is limited, as the pan bumper does not extend alongside the remainder (for example, top, bottom and door latch side portions) of the sealing member 70. Any suitable material that is durable and capable of withstanding elevated operating temperatures may be used for the pan bumper.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A steam cooker comprising:
a cooking chamber having an access opening with a frame disposed thereabout;
a door movable between an open position and a closed position relative to the access opening;
a steam generator for providing steam to the cooking chamber;
a sealing member positioned at least partly between the frame and an interior side of the door when the door is in the closed position; and
at least one pan bumper extending from the interior side of the door and disposed for contacting and moving a protruding pan when the door is moved from the open position to the closed position so as to prevent contact between the protruding pan and the sealing member.

2. The steam cooker of claim 1, wherein the steam generator comprises a heating chamber, separate from the cooking chamber, defining a volume for holding water and a heating unit associated with the heating chamber in order to heat water in the heating chamber so as to generate steam.

3. The steam cooker of claim 1, wherein the cooking chamber further comprises at least one internal pan-receiving rack.

4. The steam cooker of claim 1, wherein the sealing member is attached to the interior side of the door and the pan bumper protrudes further away from the interior side of the door than the sealing member.

5. The steam cooker of claim 1, wherein the cooker operates in a temperature range between about 190 degrees F. and about 250 degrees F.

6. The steam cooker of claim 1 further comprising chamber controls positioned outside the cooking chamber and alongside the door.

7. The steam cooker of claim 1, wherein the extent of the pan bumper is restricted to the portion of the sealing member located along the hinged side of the door.

8. The steam cooker of claim 1, wherein the pan bumper is vertically oriented and positioned toward a hinged side of the door.

9. A steam cooker comprising:
a cooking chamber having an access opening;
a door providing access to the cooking chamber, the door movable between an open position and a closed position relative to the access opening;
a steam generator for providing steam to the cooking chamber;
a sealing member positioned on an interior side of the door to limit egress of steam when the door is in the closed position; and
at least one pan bumper extending from the interior side of the door and located to protrude into the access opening when the door is in the closed position, the pan bumper protruding further away from the interior side of the door than the sealing member.

10. The steam cooker of claim 9, wherein the cooking chamber further comprises at least one internal pan-receiving rack.

11. The steam cooker of claim 9, wherein the cooker operates in a temperature range between about 190 degrees F. and about 250 degrees F.

12. The steam cooker of claim 9, further comprising chamber controls positioned outside the cooking chamber and alongside the door.

13. The steam cooker of claim 9, wherein the extent of the pan bumper is restricted to the portion of the sealing member located along the hinged side of the door.

14. The steam cooker of claim 9, wherein the at least one pan bumper is comprised of an L-shaped bracket.

15. The steam cooker of claim 9, wherein the pan bumper is vertically oriented and positioned toward a hinged side of the door.
